(19) United States
(12) Patent Application Publication
(10) Pub. No.: US 2011/0085061 A1
(43) Pub. Date: Apr. 14, 2011

(54) IMAGE PHOTOGRAPHING APPARATUS AND METHOD OF CONTROLLING THE SAME

(75) Inventor: Byoung Woo Kim, Seoul (KR)

(73) Assignee: Samsung Electronics Co., Ltd., Suwon-si (KR)

(21) Appl. No.: 12/888,526

(22) Filed: Sep. 23, 2010

(30) Foreign Application Priority Data
Oct. 8, 2009 (KR) 2009-95552

(51) Int. Cl. H04N 5/262

(52) U.S. Cl. 348/240.99; 348/E05.055

(57) ABSTRACT

An image photographing apparatus to adjust gain and directivity of a signal input via a microphone according to the position of a subject, and a method of controlling the same. The image photographing apparatus includes a face recognition unit to detect a face of a subject, a control unit to calculate a distance between the subject and the image photographing apparatus according to zoom ratio information of the image photographing apparatus and the size of the face and to calculate a position angle of the subject according to the zoom ratio information of the image photographing apparatus and a position coordinate of the subject, and an audio processing unit to adjust gain of a signal input via a microphone according to the distance between the image photographing apparatus and the subject and to adjust directivity of the signal input via the microphone according to the position angle of the subject.

### CROSS-REFERENCE TO RELATED APPLICATIONS

This application claims priority under 35 U.S.C. §119(a) from Korean Patent Application No. 2009-0095552, filed on Oct. 8, 2009 in the Korean Intellectual Property Office, the disclosure of which is incorporated herein by reference in its entirety.

### BACKGROUND

1. Field of the Invention

Embodiments of the present general inventive concept relate to an image photographing apparatus to adjust gain and directivity of a signal input via a microphone according to the position of a subject, and a method of controlling the same.

2. Description of the Related Art

A microphone used in an image photographing apparatus may be divided into an omnidirectional microphone, a unidirectional microphone, and a super-directional microphone according to directivity of sound to be collected. The omnidirectional microphone responds to sounds coming from all directions with the same sensitivity. The unidirectional microphone responds to sounds coming from a specific direction and the response thereof decreases away from the axis of the specific direction. The unidirectional microphone is useful for collecting only specific sounds in a place where there is much noise. The super-directional microphone collects only sounds within a narrow angle, such as a gun microphone or a microphone in which a sound collecting plate such as a parabolic antenna is mounted on the backside of the gun microphone. Since a sound receiving angle of the super-directional microphone is 10° to 20°, the super-directional microphone is efficiently used when only specific sounds of various sounds are collected.

### SUMMARY

Therefore, the present general inventive concept can provide an image photographing apparatus to adjust gain of a signal input via a microphone according to the distance of a subject, and a method of controlling the same.

The present general inventive concept can provide an image photographing apparatus to adjust directivity of a signal input via a microphone according to the distance of a subject, and a method of controlling the same.

Additional features and utilities of the present general inventive concept will be set forth in part in the description which follows and, in part, will be obvious from the description, or may be learned by practice of the present general inventive concept.

Exemplary embodiments of the present general inventive concept can provide a method of controlling an image photographing apparatus, the method including calculating a distance between the image photographing apparatus and a subject according to a zoom ratio of the image photographing apparatus and a facial size of the subject, and adjusting gain of a signal input via a microphone according to the distance.

The method may further include calculating a position angle of the subject and adjusting directivity of the signal input via the microphone according to the position angle of the subject.

The calculating of the position angle of the subject may include checking a position coordinate of the subject and calculating the position angle proportional to a distance between the position coordinate and a central coordinate of a screen of the image photographing apparatus.

The calculating of the position angle of the subject may include correcting the position angle proportional to the distance between the position coordinate and the central coordinate of the screen of the image photographing apparatus according to the zoom ratio of the image photographing apparatus, and calculating the position angle of the subject.

The calculating of the distance between the image photographing apparatus and the subject may include estimating the distance between the image photographing apparatus and the subject according to the facial size of the subject, correcting the estimated distance according to the zoom ratio of the image photographing apparatus, and calculating the distance between the image photographing apparatus and the subject.

The estimating of the distance between the image photographing apparatus and the subject according to the facial size of the subject may include estimating the distance between the image photographing apparatus and the subject according to a table in which the facial size of the subject is mapped to the distance.

The adjusting of the gain of the signal input via the microphone according to the distance may include adjusting the intensity of the gain of the signal input via the microphone in proportion to the distance.

The method may also include receiving a selection of a face recognition audio mode with the image photographic apparatus.

The method may also include when it is determined that the face recognition audio mode is selected, detecting a face of the subject of an image input into the image photographing apparatus.

The detecting the face of the subject in the method may include extracting a feature value of the face.

The detecting the face of the subject in the method may include detecting the face of the subject using template matching.

The method may include when the face of the subject is detected, calculating a facial size and estimating a distance of the subject using the calculated facial size.

The method may include correcting the estimated distance between the subject and the image forming apparatus according to the zoom ratio of the image photographing apparatus.

Exemplary embodiments of the present general inventive concept can also provide a method of controlling an image photographing apparatus, the method including calculating a position angle of a subject according to a zoom ratio of the image photographing apparatus and a position coordinate of the subject, and adjusting directivity of a signal input via a microphone according to the position angle.

The calculating of the position angle of the subject may include checking a position coordinate of the subject and calculating the position angle proportional to a distance between the position coordinate and a central coordinate of a screen of the image photographing apparatus.

The calculating of the position angle of the subject may include correcting the position angle proportional to the distance between the position coordinate and the central coordinate of the screen of the image photographing apparatus according to the zoom ratio of the image photographing apparatus, and calculating the position angle of the subject.

The method may further include calculating a distance between the image photographing apparatus and the subject according to a facial size of the subject and the zoom ratio of the image photographing apparatus, and adjusting gain of the signal input via the microphone according to the distance.

The calculating of the distance between the image photographing apparatus and the subject may include estimating the distance between the image photographing apparatus and the subject according to the facial size of the subject, correcting the estimated distance according to the zoom ratio of the image photographing apparatus, and calculating the distance between the image photographing apparatus and the subject.

The estimating of the distance between the image photographing apparatus and the subject according to the facial size of the subject may include estimating the distance between the image photographing apparatus and the subject according to a table in which the facial size of the subject is mapped to the distance.

The adjusting of the gain of the signal input via the microphone according to the distance may include adjusting the intensity of the gain of the signal input via the microphone in proportion to the distance.

The method may also include receiving a selection of a face recognition audio mode with the image photographic apparatus.

The method may also include when it is determined that the face recognition audio mode is selected, detecting a face of the subject of an image input into the image photographing apparatus.

The detecting the face of the subject in the method may include extracting a feature value of the face.

The detecting the face of the subject in the method may include detecting the face of the subject using template matching.

The method may include when the face of the subject is detected, calculating a facial size and estimating a distance of the subject using the calculated facial size.

The method may include correcting the estimated distance between the subject and the image forming apparatus according to the zoom ratio of the image photographing apparatus.

Exemplary embodiments of the present general inventive concept also provide an image photographing apparatus including a face recognition unit to detect a face of a subject, a control unit to calculate a distance between the subject and the image photographing apparatus according to zoom ratio information of the image photographing apparatus and a size of the face, and an audio processing unit to adjust gain of a signal input via a microphone according to the distance.

The control unit may estimate the distance between the image photographing unit and the subject according to the size of the face of the subject, correct the estimated distance according to the zoom ratio of the image photographing apparatus, and calculate the distance between the image photographing apparatus and the subject.

The audio processing unit may adjust the intensity of the gain of the signal input via the microphone in proportion to the calculated distance.

Exemplary embodiments of the present general inventive concept also provide an image photographing apparatus including a control unit to calculate a position angle of a subject according to zoom ratio information of the image photographing apparatus and a position coordinate of the subject, and an audio processing unit to adjust directivity of a signal input via a microphone according to the position angle.

The control unit may check the position coordinate of the subject and calculate the position angle proportional to a distance between the position coordinate and a central coordinate of a screen of the image photographing apparatus.

The control unit may correct the position angle proportional to the distance between the position coordinate and the central coordinate of the screen of the image photographing apparatus according to the zoom ratio of the image photographing apparatus, and calculate the position angle of the subject.

Exemplary embodiments of the present general inventive concept can also provide that the gain of the signal input via the microphone may be adjusted according to the distance between the image photographing apparatus and the subject and the directivity of the signal input via the microphone may be adjusted according to the position angle of the subject.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1A is a perspective view illustrating the front and right surfaces of an image photographing apparatus according to exemplary embodiments of the present general inventive concept;

FIG. 1B is a perspective view illustrating the rear and left surfaces of the image photographing apparatus according to exemplary embodiments of the present general inventive concept;

FIG. 2 illustrates a control block diagram of the image photographing apparatus according to exemplary embodiments of the present general inventive concept;

FIGS. 3A to 3C are diagrams illustrating the control of directivity of a microphone of the image photographing apparatus according to exemplary embodiments of the present general inventive concept;

FIG. 4 is a block diagram illustrating an arrangement of microphone portions in a microphone according to exemplary embodiments of the present general inventive concept;

FIGS. 5A to 5C are diagrams illustrating a Spatial Directivity Pattern (SDP) of the microphone in a polar coordinate system according to exemplary embodiments of the present general inventive concept;

FIG. 6 is a diagram illustrating an SDP formed by scaling beamforming in a polar coordinate system according to exemplary embodiments of the present general inventive concept; and

FIG. 7 is a flowchart illustrating a method of controlling the image photographing apparatus according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

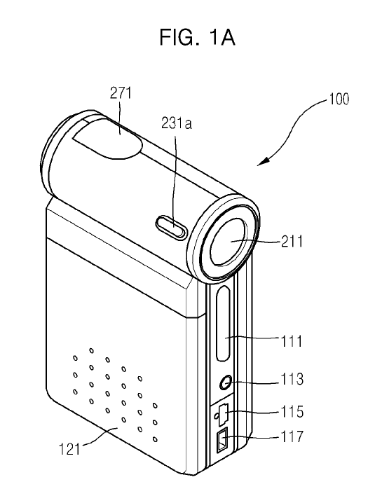

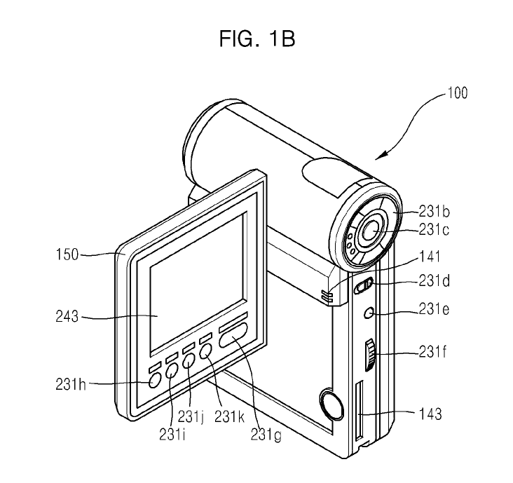

FIG. 1A is a perspective view illustrating the front and right surfaces of an image photographing apparatus 100 according to exemplary embodiments of the present general inventive concept, and FIG. 1B is a perspective view illustrating the rear and left surfaces of the image photographing apparatus 100 according to exemplary embodiments of the present general inventive concept.

The image photographing apparatus 100 can include a lens unit 211 to photograph a subject, a remote controller signal reception unit 111 to receive a remote controller signal, an earphone terminal 113 to connect an earphone, a USB (Universal Serial Bus) terminal 115 to communicate with a Personal Computer (PC) or a printer, and a power supply cable connection terminal 117 to receive external power via a power supply (not illustrated). Terminal 115 can be a USB terminal, or can be any suitable interface to communicatively connect the image photographing apparatus 100 with an external device (e.g., a PC, a printer, and/or a digital storage device) to carry out the exemplary embodiments of the present general inventive concept.

Terminals to connect external devices can be provided on the front surface of the image photographing apparatus 100, and a photo button 231a to photograph a still image and a battery cover 121 having a battery mounted therein can be provided on the right surface of the image photographing apparatus 100. In addition, a microphone 271 to receive an external sound signal can be provided on the upper surface of the image photographing apparatus 100, although the microphone 271 can be disposed in any suitable position on the image photographing apparatus 100 to carry out the exemplary embodiments of the present general inventive concept as disclosed herein.

A zoom switch 231b can zoom in and/or zoom out the lens unit 211, a shooting button 231c can shoot and/or capture a moving image, an operation mode selection switch 231d can select an operation mode (storage/reproduction/power-off mode) of the image photographing apparatus, a menu button 231e can display a menu screen on a Liquid Crystal Display (LCD) 243, and a menu dial 231f can move a cursor to a specific menu on the menu screen displayed on the LCD 243 and can select a menu on which the cursor is placed are provided on the rear surface of the image photographing apparatus 100.

A memory card mounting unit 143 can mount a memory card and a display lamp 141 including a power display lamp to emit light when the image photographing apparatus 100 is turned on and a charging display lamp to emit orange light when the image photographing apparatus 100 is being charged and to emit green light when charging is completed can be provided on a rear surface of the image photographing apparatus 100.

An LCD panel 150 can be provided on the rear surface of the image photographing apparatus 100 can include the LCD 243 to display a photographed and/or reproduced image and the menu screen, a mode button 231 g to display the menu screen on the LCD 243, a rewind button 231h, a fast forward button 231i, a play/stop button 231j, and a pause button 231k.

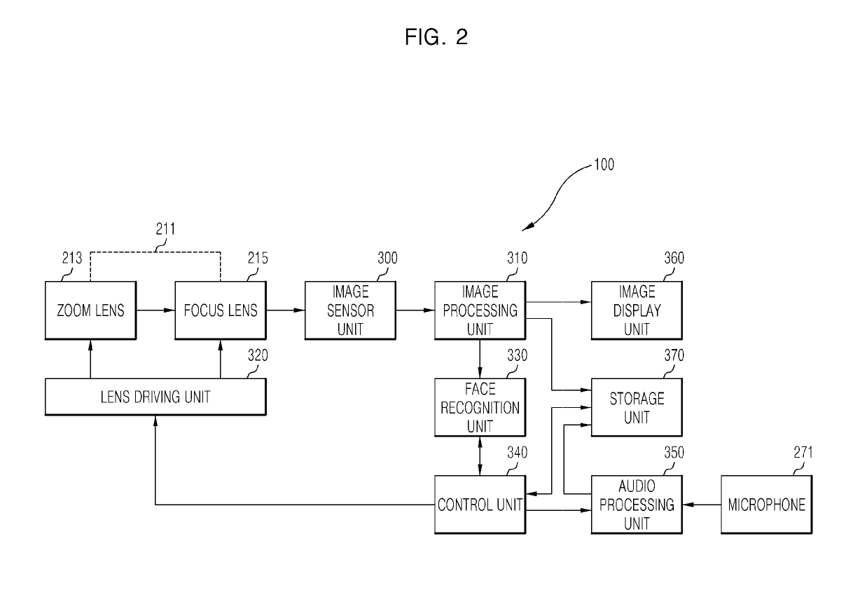

FIG. 2 illustrates a control block diagram of the image photographing apparatus 100 according to exemplary embodiments of the present general inventive concept.

As illustrated in FIG. 2, the image photographing apparatus 100 can include the lens unit 211 to focus the light reflected from a subject, an image sensor unit 300 to convert the light input via the lens unit 211 into an electrical signal and output the electrical signal, an image processing unit 310 to process an image using at least the signal input via the image sensor unit 300, a lens driving unit 320 to drive a zoom lens 213 or a focus lens 215, a face recognition unit 330 to determine a facial portion of the subject, a control unit 340 to control the image photographing apparatus, an audio processing unit 350 to adjust directivity and gain of the microphone 271, the microphone 271 having a plurality of omnidirectional microphone portions mounted therein, an image display unit 360 to output an electrical signal (e.g., image signal) that has been processed by the image processing unit 310, and a storage unit 370 to store the audio signal processed by the audio processing unit 350 and the image signal processed by the image processing unit 310.

The lens unit 211 can focus the light reflected from the subject to be photographed and can apply the light to the image sensor unit 300. The lens unit 211 can include the zoom lens 213 to zoom in or zoom out the image of the subject and the focus lens 215 to adjust the focus such that the light reflected from the subject is focused on the image sensor unit 300.

The image sensor unit 300 can convert the optical image incident via the lens unit 211 into the electrical signal and can output the electrical signal. The optical image of the subject can be formed on an optical surface of the image sensor unit 300 by the lens unit 211, and the image sensor unit 300 can convert the optical image formed on a photosensitive surface into the electrical signal and can output the one-dimensional electrical signal by horizontal and vertical scanning.

The image processing unit 310 can minimize and/or eliminate noise from the signal output from the image sensor unit 300 using a correlated double sampling circuit, can adjust gain using an auto gain controlling circuit such that the level of the signal is constantly maintained, and can convert the signal into a digital signal using an ND converter.

The lens driving unit 320 can drive the zoom lens 213 or the focus lens 215. The lens driving unit 320 can apply a predetermined control signal to a driving motor connected to the zoom lens 213 or the focus lens 215 so as to adjust the magnification of the zoom lens 213 or the position of the focus lens 215.

The face recognition unit 330 can detect whether a facial portion is present in the subject. The face can indicate the front surface of the head of a person if the subject is a person and can include eyes, a nose and ears. When detecting whether a facial portion is present in the subject, the face recognition unit 330 can convert an image into a grayscale image, searching for a face contour, eyes or the like using a boundary detection and contour extraction algorithm, divide the face into portions having a predetermined size, and recognize a pattern by shadow elimination, viewing angle correction or the like. In exemplary embodiments of the present general inventive concept, the face recognition unit 330 can extract facial features. When extracting facial features, the face recognition unit 330 can use an edge associated with a relationship between one pixel and the peripheral pixels thereof, and a local edge using an average value. That is, when an edge image and an averaged image of the whole image are obtained, the face recognition unit 330 can determine that any one pixel is an edge pixel if an edge value of the pixel is greater than an average value and is not an edge pixel if the edge value of the pixel is less than the average value. In exemplary embodiments of the present general inventive concept, edge detection can be performed using a Sobel or Prewitt mask, and averaging can be performed using a Gaussian mask. The determination of the edge can use a value which is changed by multiplying the average by a predetermined threshold. In exemplary embodiments of the present general inventive concept, one or more face detection methods may be used, such as a method using a template matching.

The control unit 340 can calculate a distance between the image photographing apparatus and the subject according to a zoom ratio of the image photographing apparatus and a facial size of the subject. The control unit 340 can estimate a distance to the subject according to the facial size. For example, the control unit 340 can estimate the distance to the subject using a table (e.g., a look-up table (“LUT”) stored in a memory of the control unit 340 and/or in the storage unit 370) of predetermined values, where a plurality of ranges of facial sizes can correspond to one or more estimated distances. That is, the control unit 340 can use the determined facial size to estimate the distance using the predetermined values in the table, as described in detail below. The control unit 340 can correct the estimated distance according to the zoom ratio of the image photographing apparatus and can calculate an actual distance between the image photographing apparatus and the subject.

When the face of the subject is detected, the control unit 340 may calculate the facial size and estimate the distance to the subject using the calculated facial size. The facial size may be calculated by determining how many pixels are occupied by an image corresponding to the facial portion detected from the whole image displayed on the image display unit 360. For example, if a user of the image photographing apparatus 100 wants to photograph a certain person, a preview image can be displayed on the image display unit 360 and the user can initiate photographing when viewing the preview image. The preview image displayed on the image display unit 360 can be analyzed in frame units so as to detect the face and calculate the facial size. The estimated distance may be calculated using a method where the facial size of the preview image decreases in a predetermined proportion to the distance of the subject from the image photographing apparatus. Although the facial size varies from person to person, since a reduction rate of a size according to the increase in the distance from a reference point is substantially constant, the estimated distance may be calculated by using a table in which the facial size and the distance are statistically mapped (e.g., a look-up table (“LUT”) including a plurality of values for facial size and corresponding distances from the reference point). For example, the facial size may be divided into a large size, a middle size, and a small size, and a table in which estimated distance differences among the sizes are mapped may be used.

The control unit 340 can correct the estimated distance between the subject and the image photographing apparatus according to the zoom ratio of the image photographing apparatus. The control unit 340 can correct the estimated distance between the subject and the image photographing apparatus by referring to a zoom table (e.g., stored in a memory unit of the control unit 340 and/or in the storage unit 370) in which information about the size of the subject according to the zoom ratio (information about the size of the subject which is changed according to the zoom ratio in a state in which the position of the subject is fixed) is stored. With respect to a subject positioned at a predetermined distance from the image photographing apparatus, if the zoom ratio is close to a wide end, the facial size is small and thus it can be determined that the distance of the subject is larger than an actual distance. If the zoom ratio is close to a telephoto end, the facial size is large and thus it can be determined that the distance of the subject is smaller than the actual distance. Accordingly, the control unit 340 can correct the estimated distance calculated according to the facial size by referring to the zoom table (e.g., stored in a memory unit of the control unit 340 and/or in the storage unit 370) in which the facial size of the subject is stored according to the zoom ratio, and can calculate the actual distance.

The control unit 340 can calculate a position angle of the subject according to a position coordinate of the subject and the zoom ratio of the image photographing apparatus. The position angle can indicate an angle (e.g., a central angle when the subject and the center of the screen are connected by a virtual line in the image photographing apparatus) representing a degree that the position of the subject is separated from the center of the screen of the image photographing apparatus.

The control unit 340 can check the position coordinate of the subject detected from the image input to the image photographing apparatus and can estimate the position angle proportional to the distance between the position coordinate of the subject and the central coordinate of the screen of the image photographing apparatus. That is, the control unit 340 can estimate the position angle using a determined distance between a determined and/or predetermined position coordinate of the subject, and a predetermined reference coordinate (e.g., the central coordinate).

The control unit 340 can correct the estimated position angle of the subject according to the zoom ratio of the image photographing apparatus. The estimated position angle can be greater than an actual position angle if the zoom ratio of the image photographing apparatus is close to the wide end and is less than the actual position angle if the zoom ratio of the image photographing apparatus is close to the telephoto end. Therefore, the control unit 340 can correct the estimated position angle of the subject by referring to the zoom table (e.g., where the zoom table is stored in a memory unit of the control unit 340 and/or the storage unit 370) for information about the position angle of the subject according to the zoom ratio (information about the position angle of the subject which is changed according to the zoom ratio in a state in which the subject is fixed) is stored, and can calculate an actual position angle.

The audio processing unit 350 can adjust the gain of the audio signal input via the microphone 271 according to the distance information of the subject received from the control unit 340. The audio processing unit 350 can determine the gain according to the distance from the subject so as to increase the efficiency of the reception of the audio signal around the subject. The audio processing unit 350 can include an Audio Gain Controller (AGC) (not illustrated), and the AGC can control the gain of the audio signal converted into the electrical signal and can amplify the audio signal. The AGC can control the gain using, for example, a pre-amplifier.

The audio processing unit 350 can adjust the directivity (i.e., beamforming) of the microphone 271 according to the position angle information of the subject received from the control unit 340. That is, the audio processing unit 350 can check the degree to which the detected subject is separated from the center of the screen, and can adjust the directivity of the microphone 271 toward the subject.

The audio processing unit 350 may perform scaling beamforming according to the position angle of the subject received from the control unit 340. The scaling beamforming can be a scaling factor that is applied to the signal input via the microphone 217 according to the directional information of a sound source. In exemplary embodiments of the present general inventive concept, the scaling factor can be a predetermined value stored in a memory unit of the audio processing unit 350 and/or in the storage unit 370. If the scaling factor is applied according to the directional information of the sound source, signal distortion that may be generated in a low frequency band can be minimized, and noise can be accurately eliminated or attenuated, to thereby accurately acquire a target sound source signal.

The microphone 271 can include a plurality of omnidirectional microphone portions which respond to sounds generated at one or more angles (e.g., all angles) with the same sensitivity. Alternatively, the microphone 271 can include one or more omnidirectional, unidirectional, and/or super-directional microphone portions to carry out the exemplary embodiments of the present general inventive concept as disclosed herein.

The storage unit 370 can store the audio signal processed by the audio processing unit 350 and the image signal processed by the image processing unit 310. The storage unit 370 can store the zoom table in which the information about the size of the subject according to the zoom ratio is stored and the zoom table in which the information about the position angle of the subject according to the zoom ratio is stored.

When a beamforming is used, a beam pattern having a specific directivity may be generated using the plurality of omnidirectional microphone portions.

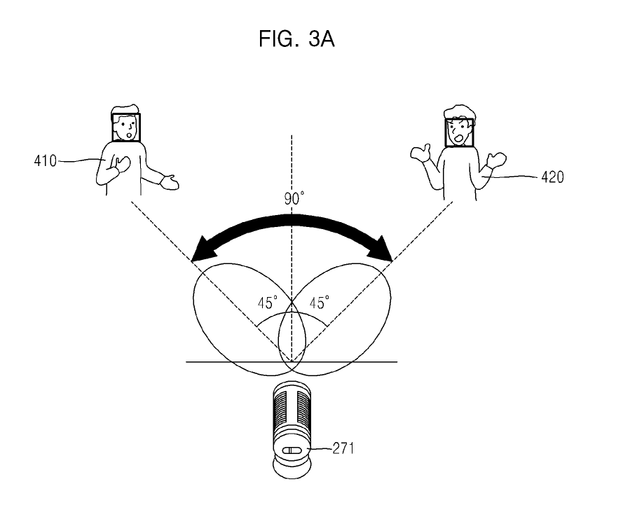

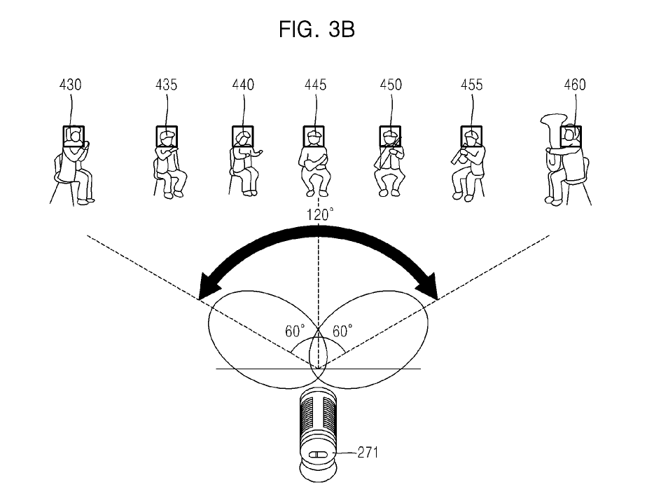

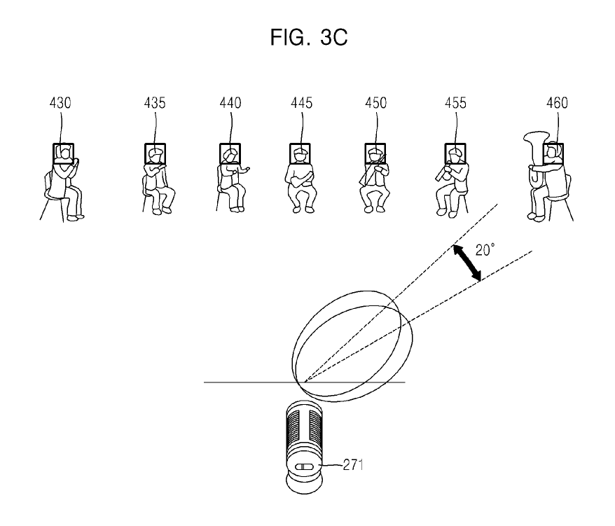

FIGS. 3A to 3C are diagrams illustrating the control of the directivity of a microphone of the image photographing apparatus 100 according to exemplary embodiments of the present general inventive concept.

As illustrated in FIG. 3A, if the position angle between any one 410 of two subjects 410 and 420 and the center of the screen is 45° in a left direction and the position angle between the other 420 of the two subjects 410 and 420 and the center of the screen is 45° in a right direction, the directivity of the microphone 271 can be set to 90° (45° with the center of the screen in the left and right directions) in a front direction on the front side of such that audio signals generated at the subjects 410 and 420 are optimally collected.

As illustrated in FIG. 3B, if the position angle between a leftmost subject 430 of a plurality of subjects 430, 435, 440, 445, 450, 455 and 460 and the center of the screen is 60° in the left direction and the position angle between the rightmost subject 460 of the plurality of subjects 430, 435, 440, 445, 450, 455 and 460 and the center of the screen is 60° in the right direction, the directivity of the microphone 271 can be set to 120° (60° with the center of the screen in the left and right directions) such that audio signals generated at the subjects 430, 435, 440, 445, 450, 455 and 460 are optimally collected.

As illustrated in FIG. 3C, if only a rightmost subject 460 of a plurality of subjects 430, 435, 440, 445, 450, 455 and 460 is manually or automatically specified and/or selected, the directivity of the microphone 271 can be adjusted such that the audio signal generated at the specified subject 460 is optimally collected. The user may manually operate the image photographing apparatus 100 so as to select subject among the plurality of subjects. When information about a selected subject is input to the image photographing apparatus, if the input subject is detected, it is recognized that the subject has been selected. Therefore, the directivity of the microphone 271 may be adjusted.

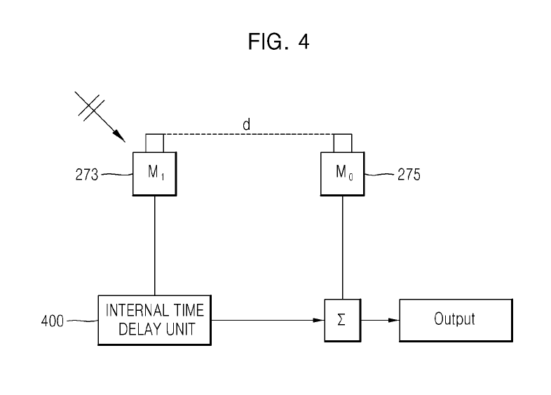

FIG. 4 is a block diagram illustrating the arrangement of microphone portions in the microphone according to exemplary embodiments of the present general inventive concept.

FIG. 4 illustrates where two microphone portions are mounted in the microphone 271 according to exemplary embodiments of the present general inventive concept and illustrates an arrangement of two microphone portions 273 and 275. Although two microphone portions 273 and 275 are illustrated, the microphone 271 can include more than two microphone portions. The plurality of microphone portions may be the same type of microphone (e.g., omnidirectional) or may include two or more types of microphones (e.g., omnidirectional, unidirectional, and/or super-directional).

When a sound signal is generated at one side of the microphone 271, the sound signal can be first input to the first microphone portion 273 and can be input to the second microphone portion 275 after a time delay corresponding to a distance “d” between the microphone portions. An input time delay, which can be generated by the positional difference between the microphone portions 273 and 275, can be referred to as external delay time and time delay which can be generated by delaying a signal by an internal time delay unit 400 is referred to as an internal delay time. A ratio of the external delay time to the internal delay time can be referred to as β, and one or more Spatial Directivity Patterns (SDPs) may be obtained by adjusting β.

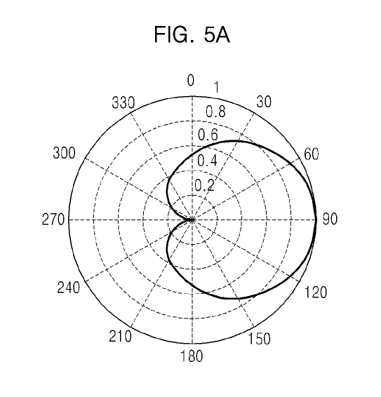

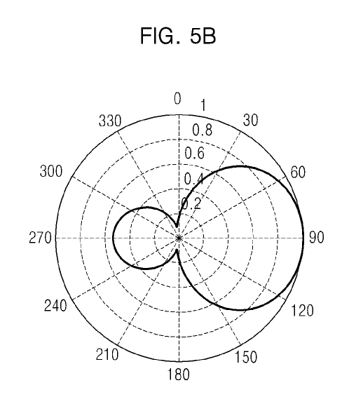

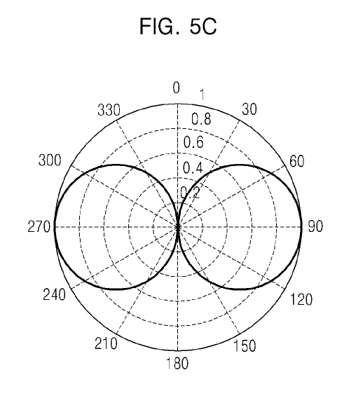

FIGS. 5A to 5C are diagrams illustrating a polar coordinate system showing an SDP according to exemplary embodiments of the present general inventive concept.

FIGS. 5A to 5C illustrate beam patterns (SDPs) which may be generated in the arrangement of the two omindirectional microphone portions shown in FIG. 4. FIG. 5A illustrates a cardioid pattern which is generated when the ratio β (external delay time/internal delay time) of the external delay time of the signal which is generated by the positional difference between the first microphone portion 273 and the second microphone portion 275 to the internal delay time which is generated by artificially delaying the signal is 1. FIG. 5B illustrates a super-cardioid pattern which is generated when the ratio β (external delay time/internal delay time) of the external delay time of the signal which is generated by the positional difference between the first microphone portion 273 and the second microphone portion 275 to the internal delay time which is generated by artificially delaying the signal is 0.3. FIG. 5C illustrates a bi-directional pattern which can be generated when the ratio β (external delay time/internal delay time) of the external delay time of the signal which is generated by the positional difference between the first microphone portion 273 and the second microphone portion 275 to the internal delay time which is generated by artificially delaying the signal is 1.

Although the beam pattern of the left and right directions can be adjusted using the microphone 271 including two microphone portions in FIGS. 4 and 5A to 5C, the beam pattern may be adjusted in directions of 0° to 360° by disposing a plurality (for example, 5) of omnidirectional microphone portions at appropriate positions according to exemplary embodiments of the present general inventive concept. Alternatively, one or more unidirectional and/or super-directional microphones may be included in the plurality of microphone portions in the microphone 271.

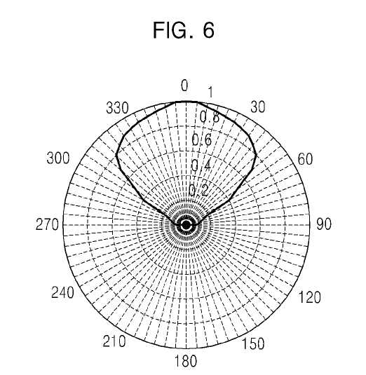

FIG. 6 is a diagram illustrating an SDP formed by scaling beamforming in a polar coordinate system according to exemplary embodiments of the present general inventive concept.

The audio processing unit 350 may perform scaling beamforming according to the position angle of the subject transmitted from the control unit 340. The scaling beamforming can be a scaling factor that is applied to the signal input via the microphone 217 according to the direction information of a sound source. If the scaling factor is applied according to the direction information of the sound source, signal distortion generated in a low frequency band can be minimized, and noise can be accurately eliminated or attenuated to acquire a target sound source signal.

Referring to FIG. 6, the audio processing unit 350 can determine that the direction of the sound source is 0° to 60°, and can apply the scaling factor of 0.5 or less to the audio signal coming at an angle of about 60° to 300° (multiplies the audio signal by a constant (e.g., 0 to 0.5)) so as to increase the robustness of the SDP and to minimize signal distortion generated in the low frequency band.

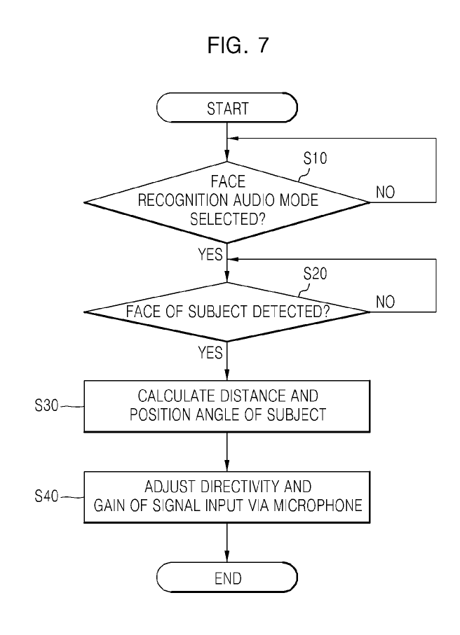

FIG. 7 is a flowchart illustrating a method of controlling the image photographing apparatus 100 according to exemplary embodiments of the present general inventive concept.

As illustrated in FIG. 7, the control unit 340 determines whether a face recognition audio mode of the image photographing apparatus is selected at operation S10. The face recognition audio mode can be a mode to recognize the face of a subject when performing photographing using the image photographing apparatus 100, calculate a distance between the image photographing apparatus 100 and the subject according to the size of the recognized face and a zoom ratio, calculate a position angle of the subject according to a position coordinate on the screen of the subject and the zoom ratio, and perform beamforming according to the calculated distance and position angle so as to generate the beam pattern having a specific directivity.

When it is determined that the face recognition audio mode is selected at operation S10, the face recognition unit 330 can detect the face of the subject of the image input to the image photographing apparatus 100 at operation S20. The face recognition unit 330 can extract the feature value of the face and/or detect the face using a template matching method.

When the information about the face of the subject is received from the face recognition unit 330, the control unit 340 can calculate the distance and the position angle of the subject using the information at operation S30. When the face of the subject is detected, the control unit 340 may calculate the facial size and estimate the distance of the subject using the calculated facial size. The facial size may be calculated by determining how many pixels are occupied by the image corresponding to the facial portion detected from the whole image displayed on the image display unit 360. The control unit 340 can correct the estimated distance between the subject and the image photographing apparatus according to the zoom ratio of the image photographing apparatus and calculate the distance between the image photographing apparatus and the subject. The control unit 340 may calculate the distance between the subject and the image photographing apparatus by referring to the zoom table in which the information about the size of the subject according to the zoom ratio is stored. The control unit 340 can check the position coordinate of the subject detected from the image input to the image photographing apparatus and estimate the angle according to the distance between the position coordinate of the subject and the central coordinate of the screen of the image photographing apparatus. The control unit 340 can correct the estimated position angle according to the zoom ratio of the image photographing apparatus and calculates a final position angle.

The audio processing unit 350 can adjust the directivity of the signal input to the microphone 271 according to the position angle of the subject calculated by the control unit 340 (beamforming) at operation S40. The adjustment of the directivity of the signal input to the microphone 271 can include arranging the microphone portions to receive a sound source at a predetermined position, adjusting the delay and the level of the signal received by the microphone portions according to the distance between the microphone portions so as to form beams, and adjusting the angle and the width of the formed beams. The beamforming can increase a Signal-to-Noise Ratio (SNR) of the audio signal according to space information of the sound source to apply the audio signal to two or more microphone portions. The audio processing unit 350 can adjust the gain of the signal input via the microphone 271 according to the calculated distance of the subject at operation S40.

Although several embodiments of the present general inventive concept have been illustrated and described, it would be appreciated by those skilled in the art that changes may be made in these embodiments without departing from the principles and spirit of the invention, the scope of which is defined in the claims and their equivalents.

What is claimed is:

1. A method of controlling an image photographing apparatus, the method comprising:
calculating a distance between the image photographing apparatus and a subject according to a zoom ratio of the image photographing apparatus and a facial size of the subject; and
adjusting gain of a signal input via a microphone according to the distance.

2. The method according to claim 1, further comprising:
calculating a position angle of the subject and adjusting directivity of the signal input via the microphone according to the position angle of the subject.

3. The method according to claim 2, wherein the calculating of the position angle of the subject includes checking a position coordinate of the subject and calculating the position angle proportional to a distance between the position coordinate and a central coordinate of a screen of the image photographing apparatus.

4. The method according to claim 3, wherein the calculating of the position angle of the subject includes correcting the position angle proportional to the distance between the position coordinate and the central coordinate of the screen of the image photographing apparatus according to the zoom ratio of the image photographing apparatus, and calculating the position angle of the subject.

5. The method according to claim 1, wherein the calculating of the distance between the image photographing apparatus and the subject includes estimating the distance between the image photographing apparatus and the subject according to the facial size of the subject, correcting the estimated distance according to the zoom ratio of the image photographing apparatus, and calculating the distance between the image photographing apparatus and the subject.

6. The method according to claim 5, wherein the estimating of the distance between the image photographing apparatus and the subject according to the facial size of the subject includes estimating the distance between the image photographing apparatus and the subject according to a table in which the facial size of the subject is mapped to the distance.

7. The method according to claim 1, wherein the adjusting of the gain of the signal input via the microphone according to the distance includes adjusting the intensity of the gain of the signal input via the microphone in proportion to the distance.

8. The method according to claim 1, further comprising:
receiving a selection of a face recognition audio mode with the image photographic apparatus.

9. The method according to claim 8, further comprising:
when it is determined that the face recognition audio mode is selected, detecting a face of the subject of an image input into the image photographing apparatus.

10. The method according to claim 9, wherein the detecting the face of the subject comprises:
extracting a feature value of the face.

11. The method according to claim 9, wherein the detecting the face of the subject comprises:
detecting the face of the subject using template matching.

12. The method of claim 9, further comprising:
when the face of the subject is detected, calculating a facial size and estimating a distance of the subject using the calculated facial size.

13. The method according to claim 12, further comprising:
correcting the estimated distance between the subject and the image forming apparatus according to the zoom ratio of the image photographing apparatus.

14. A method of controlling an image photographing apparatus, the method comprising:
calculating a position angle of a subject according to a zoom ratio of the image photographing apparatus and a position coordinate of the subject; and
adjusting directivity of a signal input via a microphone according to the position angle.

15. The method according to claim 14, wherein the calculating of the position angle of the subject includes checking a position coordinate of the subject and calculating the position angle proportional to a distance between the position coordinate and a central coordinate of a screen of the image photographing apparatus.

16. The method according to claim 15, wherein the calculating of the position angle of the subject includes correcting the position angle proportional to the distance between the position coordinate and the central coordinate of the screen of the image photographing apparatus according to the zoom ratio of the image photographing apparatus, and calculating the position angle of the subject.

17. The method according to claim 14, further comprising:
calculating a distance between the image photographing apparatus and the subject according to a facial size of the subject and the zoom ratio of the image photographing apparatus; and
adjusting gain of the signal input via the microphone according to the distance.

18. The method according to claim 17, wherein the calculating of the distance between the image photographing apparatus and the subject includes estimating the distance between the image photographing apparatus and the subject according to the facial size of the subject, correcting the estimated distance according to the zoom ratio of the image photographing apparatus, and calculating the distance between the image photographing apparatus and the subject.

19. The method according to claim 18, wherein the estimating of the distance between the image photographing apparatus and the subject according to the facial size of the subject includes estimating the distance between the image photographing apparatus and the subject according to a table in which the facial size of the subject is mapped to the distance.

20. The method according to claim 17, wherein the adjusting of the gain of the signal input via the microphone according to the distance includes adjusting the intensity of the gain of the signal input via the microphone in proportional to the distance.

21. The method according to claim 14, further comprising:
receiving a selection of a face recognition audio mode with the image photographic apparatus.

22. The method according to claim 15, further comprising:
when it is determined that the face recognition audio mode is selected, detecting a face of the subject of an image input into the image photographing apparatus.

23. The method according to claim 22, wherein the detecting the face of the subject comprises:
extracting a feature value of the face.

24. The method according to claim 22, wherein the detecting the face of the subject comprises:
detecting the face of the subject using template matching.

25. The method of claim 22, further comprising:
when the face of the subject is detected, calculating a facial size and estimating a distance of the subject using the calculated facial size.

26. The method according to claim 25, further comprising:
correcting the estimated distance between the subject and the image forming apparatus according to a zoom ratio of the image photographing apparatus.

27. An image photographing apparatus comprising:
a face recognition unit to detect a face of a subject;
a control unit to calculate a distance between the subject and the image photographing apparatus according to zoom ratio information of the image photographing apparatus and a size of the face; and
an audio processing unit to adjust gain of a signal input via a microphone according to the distance.

28. The image photographing apparatus according to claim 27, wherein the control unit estimates the distance between the image photographing unit and the subject according to the size of the face of the subject, corrects the estimated distance according to the zoom ratio of the image photographing apparatus, and calculates the distance between the image photographing apparatus and the subject.

29. The image photographing apparatus according to claim 27, wherein the audio processing unit adjusts the intensity of the gain of the signal input via the microphone in proportion to the calculated distance.

30. An image photographing apparatus comprising:
a control unit to calculate a position angle of a subject according to zoom ratio information of the image photographing apparatus and a position coordinate of the subject; and
an audio processing unit to adjust directivity of a signal input via a microphone according to the position angle.

31. The image photographing apparatus according to claim 30, wherein the control unit checks the position coordinate of the subject and calculates the position angle proportional to a distance between the position coordinate and a central coordinate of a screen of the image photographing apparatus.

32. The image photographing apparatus according to claim 30, wherein the control unit corrects the position angle proportional to the distance between the position coordinate and the central coordinate of the screen of the image photographing apparatus according to the zoom ratio of the image photographing apparatus, and calculates the position angle of the subject.
